(19) United States
(12) Patent Application Publication
(10) Pub. No.: US 2013/0264155 A1
(43) Pub. Date: Oct. 10, 2013

(54) Caliper for Disc Brakes

(71) Applicant: YU-ZHONG HUANG, New Taipei City (TW)

(72) Inventor: YU-ZHONG HUANG, New Taipei City (TW)

(21) Appl. No.: 13/439,849

(22) Filed: Apr. 5, 2012

(51) Int. Cl. F16D 65/092; F16D 55/22

(52) U.S. Cl. 188/73.47

(57) ABSTRACT

An improved caliper for disk brakes includes two housings opposite to each other, wherein the improvement comprises: each housing is embedded with an integrally formed cup of metal to serve as a hydraulic chamber for brake fluid, one of the housings is provided with a brake-fluid inlet to communicate with one cup of the housing provided with the brake-fluid inlet, and each housing is provided with hydraulic tubes for connecting the cup therein to a brake-fluid outlet thereof and for connecting the cup therein to a brake-fluid communicating port thereof, so that the problem of the brake-fluid leakage in the conventional calipers, due to slits or pores existed in the bodies of the calipers from casting or die-casting, can be avoided, and the strength to withstand the hydraulic pressure of brake fluid can be increased, so that the yield and quality of the associated product can be improved.

### TECHNICAL FIELD OF THE INVENTION

The present invention relates to an improved caliper for disk brakes, and more particularly to a caliper including two housings made by casting or die-casting, wherein each housing is embedded with an integrally formed cup of metal.

### DESCRIPTION OF THE PRIOR ART

A caliper for disk brakes generally comprises two separate bodies, each of which defines a hydraulic chamber that can be installed with a piston. Each piston is attached with a pad or shoe. During braking, the hydraulic pressure behind each piston can push each piston outward, so that the pad can be forced into contact with a disc. The resulting frictional contact can slow and stop the disc and the associated wheel.

Currently, the bodies of the existing calipers are usually molded by casting or die-casting. Thereafter, the bodies are processed by mechanical methods to form hydraulic chambers therein, which can be stored with brake fluid. However, this way of making calipers usually has following disadvantages:

1. The bodies of the calipers are molded by casting or die-casting, and then are mechanically processed to form the hydraulic chambers. The manufacturing process is time-consuming, and the cost is high.

2. Due to the characteristics of casting or die-casting, the bodies of the calipers may embody slits or pores, which cannot be identified by the human eye. If they are not inspected to ensure their quality, leakage of brake fluid will usually occur. To avoid the leakage problem, every caliper should be inspected by optical equipment or pressure machine to ensure their quality. Thus, the manufacturing cost will be increased and the market competitiveness cannot be promoted.

In view of the foregoing, the applicant has contrived an improved caliper for disc brakes to overcome the disadvantages, after striving for an innovation on the existing products.

### SUMMARY OF THE INVENTION

The primary object of the present invention is to provide an improved caliper for disk brakes, which includes two housings opposite to each other, wherein the improvement comprises: each housing is embedded with an integrally formed cup of metal to serve as a hydraulic chamber for brake fluid, one of the housings is provided with a brake-fluid inlet to communicate with one cup of the housing provided with the brake-fluid inlet, each housing is provided with hydraulic tubes for connecting the cup therein to a brake-fluid outlet thereof and for connecting the cup therein to a brake-fluid communicating port thereof; so that, by using the cup and the hydraulic tubes, each without slits or pores, embedded in the housings, the bad quality of the conventional calipers, due to slits or pores existed in the bodies of the calipers from casting or die-casting, can be alleviated, so that the product yield and quality can be improved.

According to one aspect of the present invention, the material used in manufacturing the cup can be aluminum alloy, stainless steel, alloy steel or the like. The cup of the present invention can be formed by mechanical processing of lathe or milling machine. The cup of the present invention is not limited to any materials or processing methods.

According to another aspect of the present invention, the two housings are assembled together by means of fasteners. The two housings are manufactured by casting or die-casting. Each of the housings is embedded with the cup, and is provided with the hydraulic tubes for connecting the cup therein to the brake-fluid outlet thereof and for connecting the cup therein to the brake-fluid communicating port thereof. The brake-fluid inlet is communicated with one cup of the housing provided with the brake-fluid inlet. Also, the two brake-fluid communicating ports of the housings are communicated by means of a connecting tube, so that the cups of the two housings can be communicated with each other.

According to a further aspect of the present invention, each housing is embedded with a plurality of cups and is provided with hydraulic tubes connected between the cups, and one cup of the housing provided with the brake-fluid inlet is provided with an inlet for communicating with the brake-fluid inlet.

According to a still further aspect of the present invention, the two housings are formed into an integral caliper or body. In manufacturing the integral caliper, the integrally formed cups and the hydraulic tubes are placed in a mold for casting or die-casting of a housing. After the casting or die-casting is completed, the integrally formed cups and the hydraulic tubes can be embedded in the housing.

According to a still further aspect of the present invention, each cup defines an annular groove on an inner surface thereof for being fitted with a seal.

According to a still further aspect of the present invention, since the cups used for storing brake fluid are made from metals and integrally formed by mechanical processing, they are free of slits, cracks or pores, so that the problem of the brake fluid leakage can be avoided, and the strength to withstand the hydraulic pressure of brake fluid can be increased, so that the yield and quality of the associated product can be improved, and the competitiveness of the associated product can be increased.

Other objects, advantages, and novel features of the present invention will become more apparent from the following detailed description when taken in conjunction with the accompanying drawings.

### BRIEF DESCRIPTION OF THE DRAWINGS

FIG. 1 shows a 3-dimensional view of the present invention that is in molding

FIG. 2 is an exploded view of the present invention after it is molded.

FIG. 3 shows a 3-dimensional view of an application of the present invention.

FIG. 4 shows a cross-sectional view of the application shown in FIG. 3.

FIG. 5 shows a 3-dimensional view of another embodiment of the present invention.

FIG. 6 shows a cross-sectional view of the embodiment shown in FIG. 5.

### DETAILED DESCRIPTION OF THE PREFERRED EMBODIMENTS

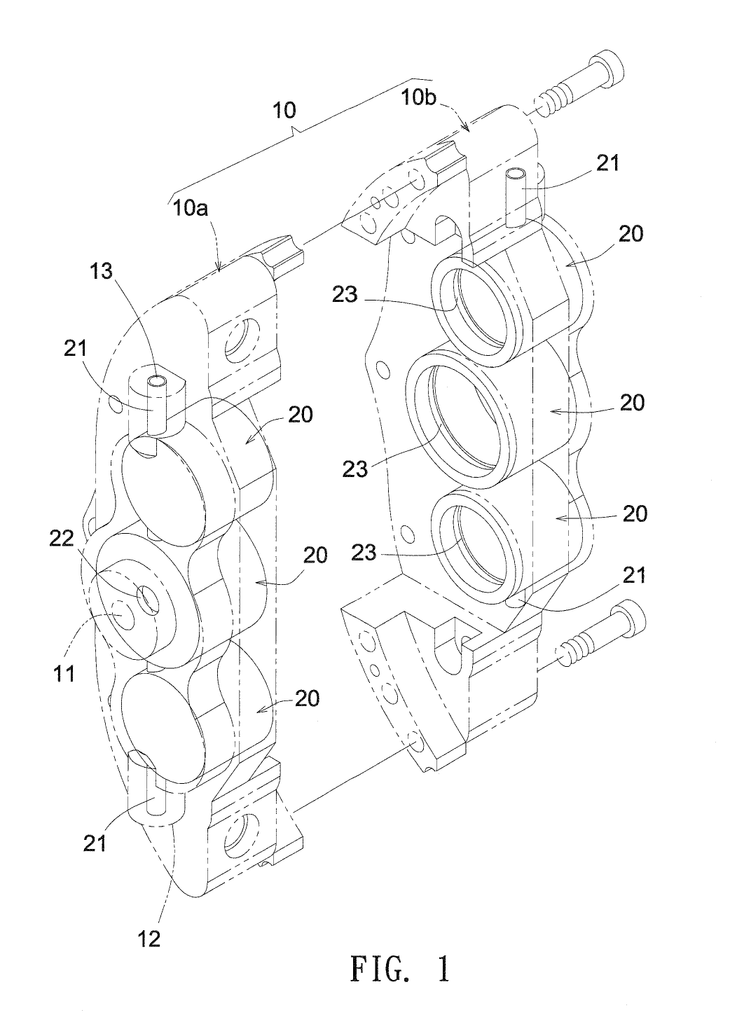

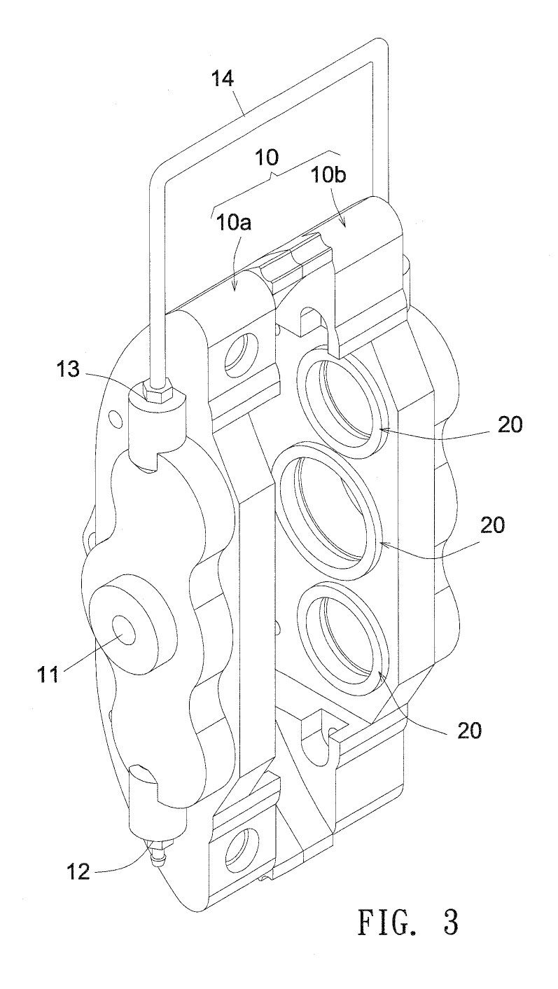

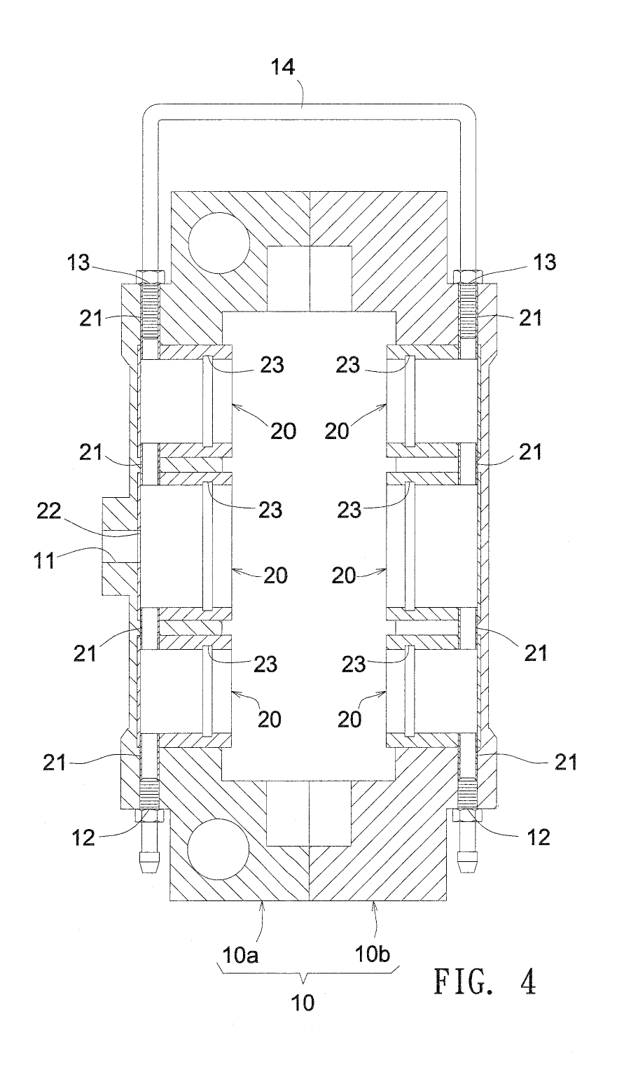

Referring to FIGS. 1-4, the present invention relates to an improved caliper 10 for disc brakes, which includes two housings 10a, 10b located opposite to each other, wherein each of the housings is provided with a brake-fluid outlet 12 and a brake-fluid communicating port 13, and one of the housings 10a, 10b is provided with a brake-fluid inlet 11. The improvement comprises: the housings 10a, 10b are molded by casting or die-casting, each housing is embedded with a plurality of cups 20, which are made from metals and integrally formed by mechanical processing, to serve as hydraulic chambers for brake fluid, the brake-fluid inlet 11 is communicated with one cup of the housing provided with the brake-fluid inlet 11, and each housing is provided with hydraulic tubes 21 for connecting one cup 20 therein to the brake-fluid outlet 12 thereof and for connecting one cup 20 therein to the brake-fluid communicating port 13 thereof and for connecting between cups 20. By using cups 20 and hydraulic tubes 21, each without slits or pores, embedded in the housings 10a, 10b, the leakage problem of the conventional calipers due to slits or pores existed in the bodies of the calipers from casting or die-casting can be avoided, so that the product yield and quality can be improved.

The material used in manufacturing the cups 20 of the present invention can be aluminum alloy, stainless steel, alloy steel or the like. The cups 20 of the present invention can be formed by mechanical processing of lathe or milling machine. The cups 20 of the present invention are not limited to any materials or processing methods.

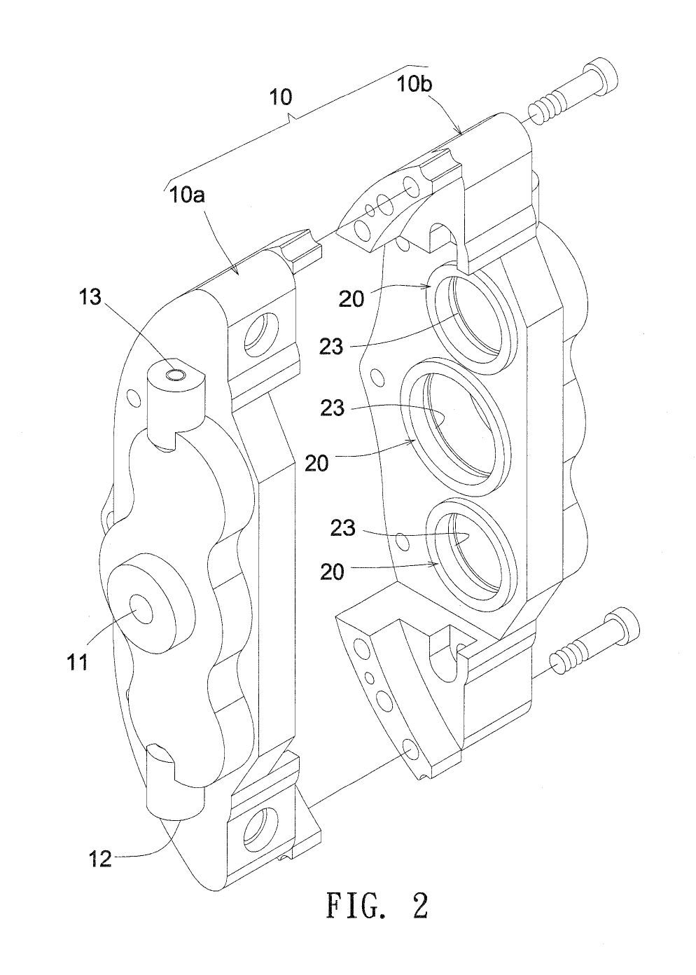

As shown in FIGS. 2, 3 and 4, the two housings 10a, 10b of the caliper 10 are located opposite to each other and assembled together by means of fasteners. The two housings 10a, 10b are manufactured by casting or die-casting. Each of the housings 10a, 10b is embedded with a plurality of cups 20, and is provided with hydraulic tubes 21 for connecting one cup 20 therein to the brake-fluid outlet 12 thereof and for connecting one cup 20 therein to the brake-fluid communicating port 13 thereof and for connecting between cups 20. The two brake-fluid communicating ports 13 of the housings 10a, 10b are communicated by means of a connecting tube 14, so that the cups 20 of the two housings 10a, 10b can be communicated with each other. The brake-fluid inlet 11 is communicated with one cup of the housing provided with the brake-fluid inlet 11.

In the improved caliper of the present invention, the two housings 10a, 10b are respectively provided with a plurality of integrally formed cups 20, which are communicated via the hydraulic tubes 21, so that brake fluid can flow into each cup. Also, one cup of the housing 10a or 10b is provided with an inlet 22 for communicating with the brake-fluid inlet 22 of the housing 10a or 10b. The present invention does not limit the number of the cups 10 employed in the housings 10a, 10b. The number of the cups 20 in each housing can be one or more than one.

In manufacturing the caliper of the present invention, the integrally formed cups 20 and the hydraulic tubes 21 can be firstly placed in a mold for the housing 10a or 10b, and then a casting or die-casting process can be conducted to form the housing 10a or 10b, so that the integrally formed cups 20 and the hydraulic tubes 21 can be embedded in the housing 10a or 10b.

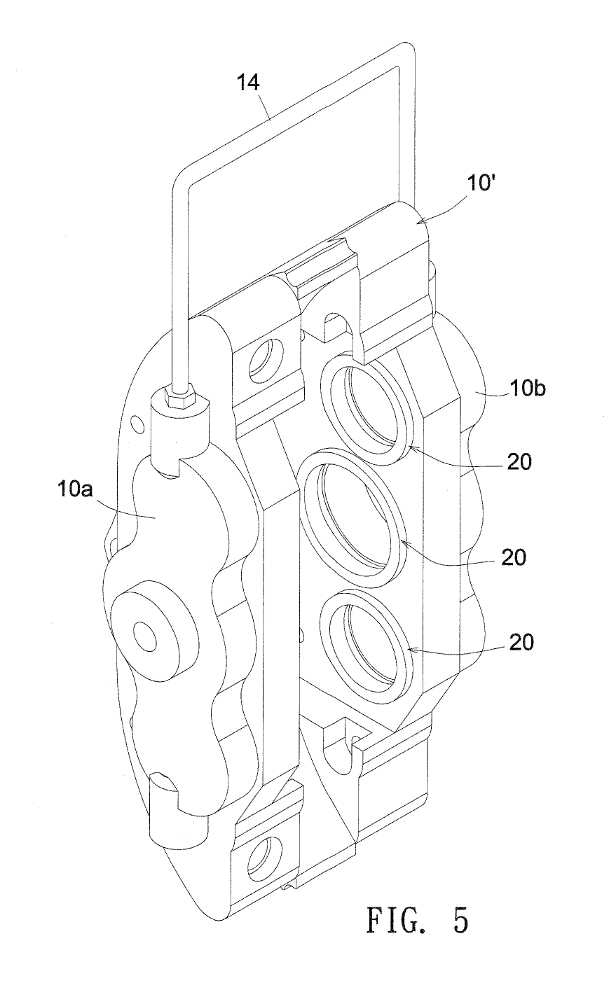

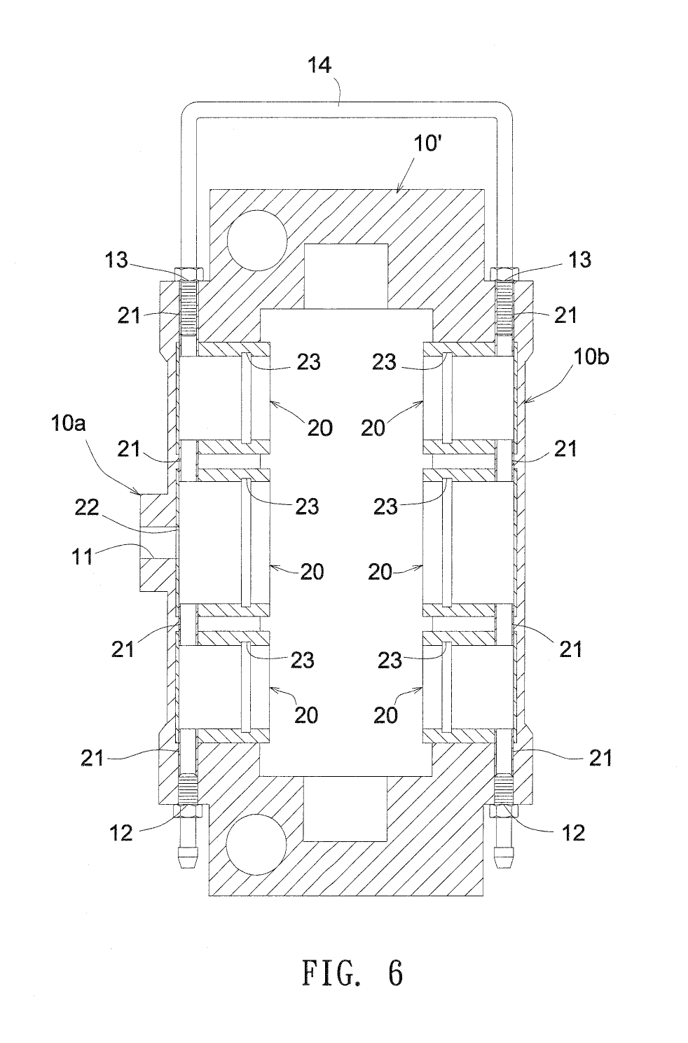

Turning now to FIGS. 5 and 6, in the improved caliper of the present invention, the two housings 10a, 10b are formed into an integral caliper or body 10′. In manufacturing the integral caliper 10′, the integrally formed cups 20 and the hydraulic tubes 21 are firstly placed in a mold for casting or die-casting of the housing 10a or 10b. After the casting or die-casting is completed, the integrally formed cups 20 and the hydraulic tubes 21 can be embedded in the housing 10a or 10b.

In the improved caliper of the present invention, each of the cups 20 defines an annular groove 23 on an inner surface thereof for being fitted with a seal.

Since the cups 20 used for storing brake fluid are made from metals and integrally formed by mechanical processing, they are free of slits, cracks or pores, so that the problem of the brake fluid leakage can be avoided, and the strength to withstand the hydraulic pressure of brake fluid can be increased, so that the yield and quality of the associated product can be improved, and the competitiveness of the associated product can be increased.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. An improved caliper for disc brakes, which comprises two housings located opposite to each other, each of said housings provided with a brake-fluid outlet and a brake-fluid communicating port, one of said housings provided with a brake-fluid inlet, wherein the improvement comprises: said housings are molded by casting or die-casting, each said housing is embedded with an integrally formed cup to serve as a hydraulic chamber for brake fluid, each said housing is provided with hydraulic tubes for connecting said cup therein to said brake-fluid outlet thereof and for connecting said cup therein to said brake-fluid communicating port thereof, the two brake-fluid communicating ports of said housings are communicated by means of a connecting tube, and said brake-fluid inlet is communicated with one cup of the housing provided with said brake-fluid inlet.

2. An improved caliper for disk brakes as claimed in claim 1, wherein each of said housings is embedded with a plurality of cups that are each integrally formed to serve as a hydraulic chamber for brake fluid, each of said housings is provided with hydraulic tubes connected between said cups, and one cup of the housing provided with said brake-fluid inlet is provided with an inlet for communicating with said brake-fluid inlet.

3. An improved caliper for disk brakes as claimed in claim 1, wherein said two housings are assembled by means of fasteners.

4. An improved caliper for disk brakes as claimed in claim 1, wherein said two housings are formed into an integral body by means of casting or die-casting.

5. An improved caliper for disk brakes as claimed in claim 1, wherein each said cup is provided with an annular groove on an inner surface thereof.

6. An improved caliper for disk brakes as claimed in claim 2, wherein each said cup is provided with an annular groove on an inner surface thereof.
